(19) United States
(12) Patent Application Publication
(10) Pub. No.: US 2022/0058449 A1
(43) Pub. Date: Feb. 24, 2022

(54) SYSTEMS AND METHODS FOR CLASSIFYING DATA USING HIERARCHICAL CLASSIFICATION MODEL

(71) Applicant: CAPITAL ONE SERVICES, LLC, McLean, VA (US)

(72) Inventors: Jeremy GOODSITT, Champaign, IL (US); Austin WALTERS, Savoy, IL (US); Anh TRUONG, Champaign, IL (US)

(73) Assignee: CAPITAL ONE SERVICES, LLC, McLean, VA (US)

(21) Appl. No.: 16/998,545

(22) Filed: Aug. 20, 2020

(51) Int. Cl. G06K 9/62; G06N 20/00

(52) U.S. Cl. CPC G06K 9/6282; G06N 20/00; G06K 9/6256

(57) ABSTRACT

A system for classifying data may include a memory unit storing instructions and one or more processors configured to execute the instructions to perform operations. The operations may include receiving data from a client device. The operations may include retrieving a hierarchical classification model from a storage device. The hierarchical classification model may include a top model and a plurality of child models arranged in a tree structure. The operations may include classifying, by the top model, the received data into a plurality of categories. The categories may include a conjoined category containing data that belongs to a subset of the categories. The categories may include classifying, by a child model of the top model, the received data within the conjoined category. The categories may include transmitting, to the client device, a result of the classifying by the top model and the child model.

### BACKGROUND

The need for efficient and effective systems to classify and cluster data arises in many fields, including data management, science, finance, engineering, environmental monitoring, water supply systems, climate studies, health care, and other areas of human activity. For example, classifying and clustering data often involves collecting and analyzing large scale, complex datasets at high velocity (i.e., “big data.”) Big data may involve datasets of such vast scale that spotting trends or outcomes requires advanced application of analytic data science or knowledge processing (e.g., artificial intelligence). Classification and clustering needs arise for all types of data (e.g., text data, numeric data, image data, video data, etc.)

Conventional methods may include training machine-learning algorithms, including neural network models, to predict or classify data. Conventional approaches typically include training and implementing an individual machine-learning model. However, an individual model may reach an inaccurate result because the model may not be well-suited to the information it is attempting to classify, or it may lack appropriate training data (e.g., it may classify inaccurately a photo of a cat as a “dog.”)

Some conventional approaches may include training and implementing a plurality of models to classify and/or cluster data. For example, a data system may train and implement different models individually to classify and/or cluster data. However, training models individually may result in inefficient use of resources. Such an approach may fail to take advantage of comparative strengths of various models. For example, one model may perform better when classifying human faces, while another performs better when classifying animals. But when classifying images that include both humans and animals, a conventional approach may simply train the two models individually to classify all of the human images and animal images, instead of training the models separately on the human images and the animal images.

Inaccurate and/or suboptimal classifications may arise in conventional approaches to classification. In conventional approaches, a classification model may be trained individually to meet performance criteria when learning to classify data (e.g., trained to minimize a loss function). Classification errors may arise, for example, when an individual classification model converges on a suboptimal number of classification categories during model training. Classification error may also arise due to user design. During training, a classification model may reach a local minimum but fail to reach a global minimum of an optimization function. Some classification models may perform better than other classification models on some data samples.

Therefore, conventional approaches suffer from inaccuracies and wasteful, inefficient use of computing resources. In view of the shortcomings and problems with conventional approaches to classify data, there is a need for unconventional approaches that improve the accuracy and efficiency of classification and clustering results by learning from and incorporating the results of a plurality of models.

### SUMMARY

The disclosed embodiments provide unconventional methods and systems for classifying data. Embodiments consistent with the present disclosure are rooted in computer technology and may include implementing a hierarchical classification model to improve the accuracy and efficiency of classifying data. The hierarchical classification model may include a top model and one or more child models arranged in a tree structure. Each top model and child model may include a machine-learning model such as a classification model. The top model may be configured to classify data into a plurality of categories, including one or more conjoined categories. Each conjoined category may contain data that belongs to more than one single category that are often confused with each other by the top model. Thus, training the top model to classify data and classifying data by the top model may be more efficient. Additionally, each child model may be configured to classify data within a corresponding conjoined category, which includes a smaller number of possible categories. Therefore, training the child model to classify data and classifying data by the child model may be more efficient, and the result of the classifying may be more accurate.

Consistent with the present embodiments, a system for classifying data is disclosed. The system may include a memory unit storing instructions and one or more processors configured to execute the instructions to perform operations. The operations may include receiving data from a client device. The operations may include retrieving a hierarchical classification model from a storage device. The hierarchical classification model may include a top model and a plurality of child models arranged in a tree structure. The operations may include classifying, by the top model, the received data into a plurality of categories. The categories may include a conjoined category containing data that belongs to a subset of the categories. The categories may include classifying, by a child model of the top model, the received data within the conjoined category. The categories may include transmitting, to the client device, a result of the classifying by the top model and the child model.

Consistent with the present embodiments, a system for generating a hierarchical classification model is disclosed. The system may include a memory unit storing instructions and one or more processors configured to execute the instructions to perform operations. The operations may include receiving a training dataset including a plurality of data elements. The operations may include generating a top model, and classifying, by the top model, the training dataset based on a set of possible categories. The set of possible categories may include categories to which the data elements within the training dataset belong. The operations may include generating a first conjoined category based on a result of the classification. The first conjoined category may be generated by joining a subset of possible categories. The operations may include updating the possible categories based on the first conjoined category, and updating the top model based on the updated possible categories. The operations may include classifying, by the updated top model, the training dataset. The classifying may result in a conjoined category. The operations may include generating a child model of the top model for the conjoined category. The operations may include constructing a hierarchical classification model including the top classification model and the child model arranged in a tree structure. The operations may include storing the hierarchical classification model in a storage device.

Consistent with the present embodiments, a method for classifying data is disclosed. The method may include receiving data from a client device. The method may include retrieving a hierarchical classification model from a storage device. The hierarchical classification model may include a top model and a plurality child models arranged in a tree structure. The method may include classifying, by the top model, the received data into a plurality of categories. The categories may include a conjoined category containing data that belongs to a subset of the categories. The method may include classifying, by a child model of the top model, the received data within the conjoined category. The method may include transmitting, to the client device, a result of the classifying by the top model and the child model.

Consistent with other disclosed embodiments, non-transitory computer readable storage media may store program instructions, which are executed by at least one processor device and perform any of the methods described herein.

The disclosed systems and methods may be implemented using a combination of conventional hardware and software as well as specialized hardware and software, such as a machine constructed and/or programmed specifically for performing functions associated with the disclosed method steps. The foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, depict several embodiments and, together with the description, serve to explain the disclosed principles. In the drawings:

FIG. 1 depicts an exemplary system for classifying data, consistent with disclosed embodiments.

FIG. 2 depicts a hierarchical classification model, consistent with disclosed embodiments.

FIGS. 3A-3F depict a method for creating a hierarchical classification model, consistent with disclosed embodiments.

FIG. 4 depicts an exemplary classification system, consistent with disclosed embodiments.

FIG. 5 is a flow chart of an exemplary process for creating a hierarchical classification model, consistent with disclosed embodiments.

FIG. 6 is a flow chart of an exemplary process for generating one or more child models in a hierarchical classification model, consistent with disclosed embodiments.

FIG. 7 is a flow chart of an exemplary process for classifying data using a hierarchical classification model, consistent with disclosed embodiments.

### DETAILED DESCRIPTION

Consistent with disclosed embodiments, systems and methods for classifying data are disclosed. Embodiments consistent with the present disclosure may include using a hierarchical classification model that include a parent model and one or more child models to classify data. As explained above, disclosed systems and methods provide accuracy, efficiency, and cost advantages over conventional approaches to classify data.

Embodiments consistent with the present disclosure may include data (i.e., datasets). Datasets may comprise actual data reflecting real-world conditions, events, and/or measurements. In some embodiments, disclosed systems and methods may fully or partially involve synthetic data (e.g., anonymized actual data or fake data). Datasets may involve time series data, numeric data, text data, and/or image data. For example, datasets may include transaction data, financial data, demographic data, public data, government data, environmental data, traffic data, network data, transcripts of video data, genomic data, proteomic data, and/or other data.

Datasets may have a plurality of dimensions, the dimensions corresponding to variables. For example, a dataset may include a time series of three-dimensional spatial data. Datasets of the embodiments may have any number of dimensions. As an illustrative example, datasets of the embodiments may include time-series data with dimensions corresponding to longitude, latitude, cancer incidence, population density, air quality, and water quality. Datasets of the embodiments may exist in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (i.e., structure), including a data type, key-value pair, label, metadata, field, relationship, view, index, package, procedure, function, trigger, sequence, synonym, link, directory, queue, or the like. Datasets of the embodiments may contain foreign keys, i.e., data elements that appear in multiple datasets and may be used to cross-reference data and determine relationships between datasets. Foreign keys may be unique (e.g., a personal identifier) or shared (e.g., a postal code). Datasets of the embodiments may be “clustered” i.e., a group of datasets may share common features, such as overlapping data, shared statistical properties, etc. Clustered datasets may share hierarchical relationships (i.e., data lineage).

Reference will now be made in detail to exemplary embodiments, examples of which are illustrated in the accompanying drawings and disclosed herein. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the systems, methods, and examples are illustrative only and are not intended to be necessarily limiting.

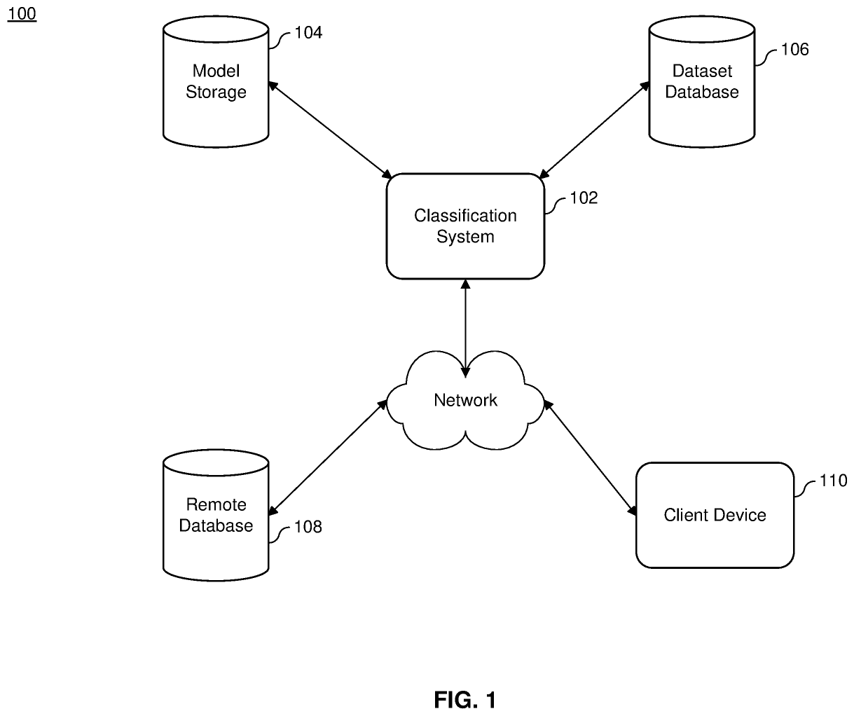

FIG. 1 depicts an exemplary system for classifying data, consistent with disclosed embodiments. As shown, system 100 may include a classification system 102, a model storage 104, a dataset database 106, a remote database 108, and a client device 110. Components of system 100 may be connected to each other via a network 112.

In some embodiments, aspects of system 100 may be implemented on one or more cloud services designed to generate (“spin-up”) one or more ephemeral container instances (e.g., AMAZON LAMBDA instances) in response to event triggers, assign one or more tasks to a container instance, and terminate (“spin-down”) a container instance upon completion of a task. By implementing methods using cloud services, disclosed systems may efficiently provision resources based on demand and provide security advantages because the ephemeral container instances may be closed and destroyed upon completion of a task. That is, the container instances do not permit access from outside using terminals or remote shell tools like SSH, RTP, FTP, or CURL, for example. Further, terminating container instances may include destroying data, thereby protecting sensitive data. Destroying data can provide security advantages because it may involve permanently deleting data (e.g., overwriting data) and associated file pointers.

As will be appreciated by one skilled in the art, the components of system 100 can be arranged in various ways and implemented with any suitable combination of hardware, firmware, and/or software, as applicable. For example, as compared to the depiction in FIG. 1, system 100 may include a larger or smaller number of classification systems, model storages, dataset databases, remote databases, client devices and/or networks. In addition, system 100 may further include other components or devices not depicted that perform or assist in the performance of one or more processes, consistent with the disclosed embodiments. The exemplary components and arrangements shown in FIG. 1 are not intended to limit the disclosed embodiments.

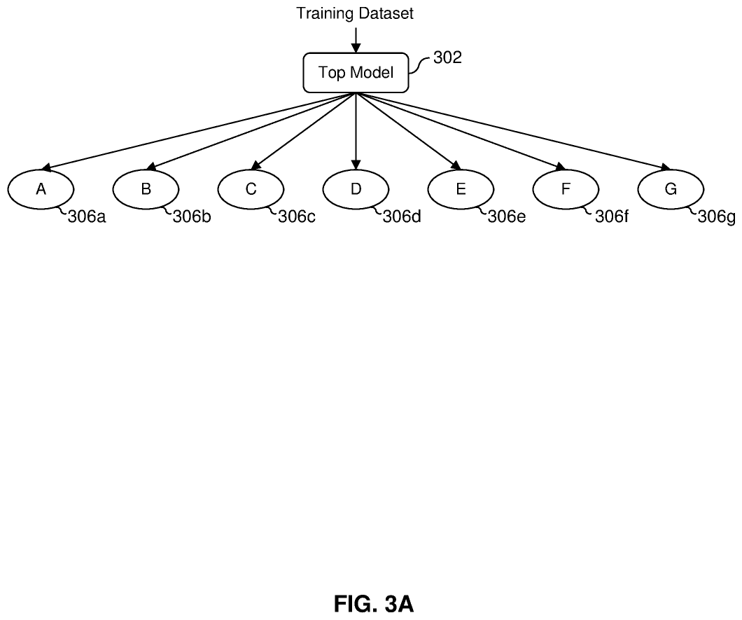

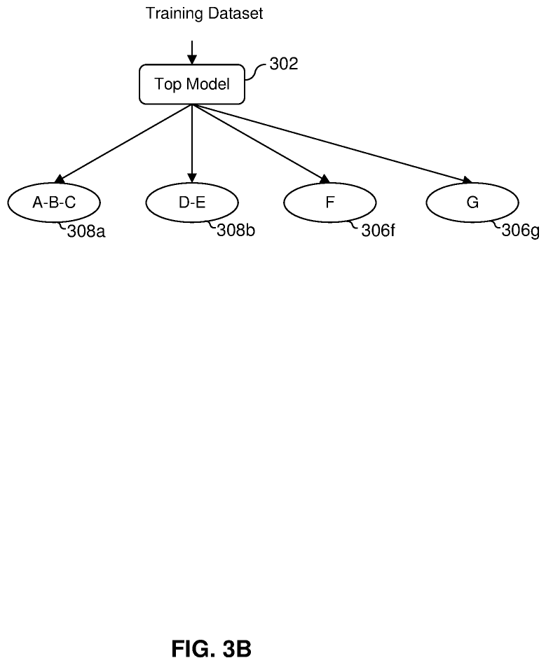

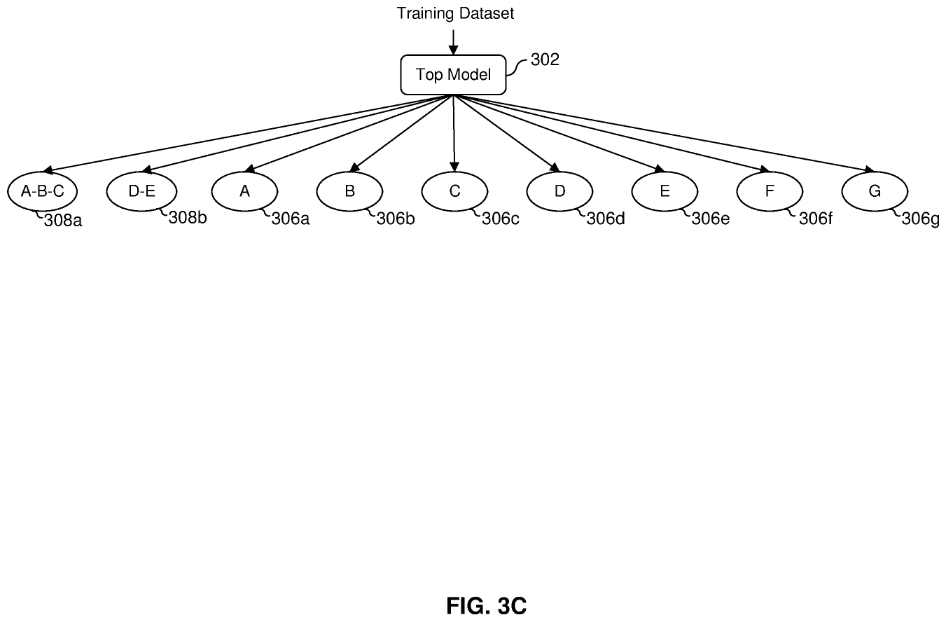

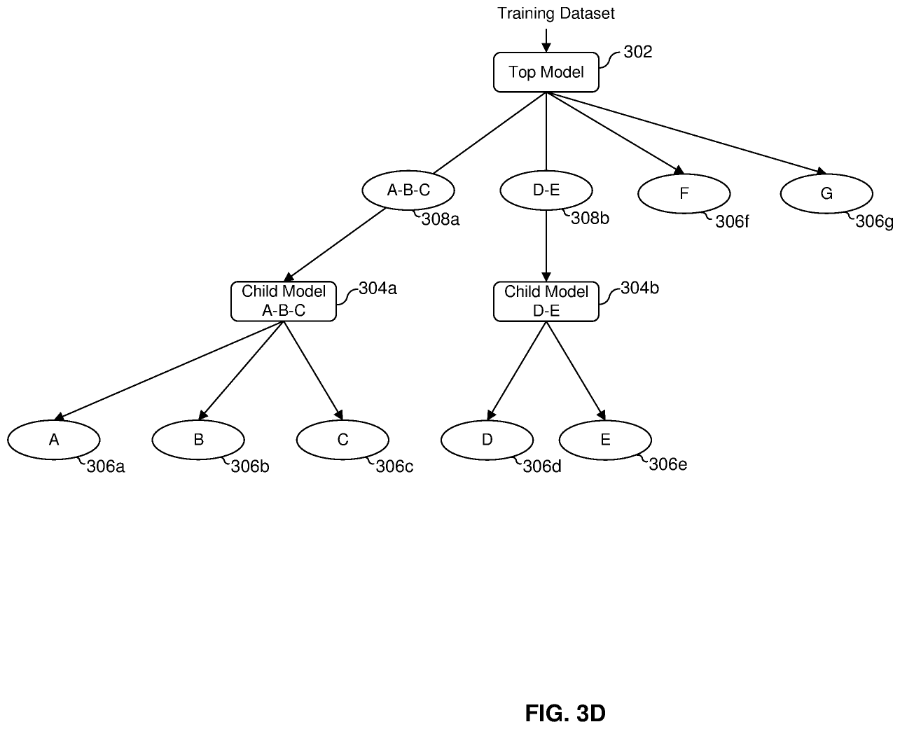

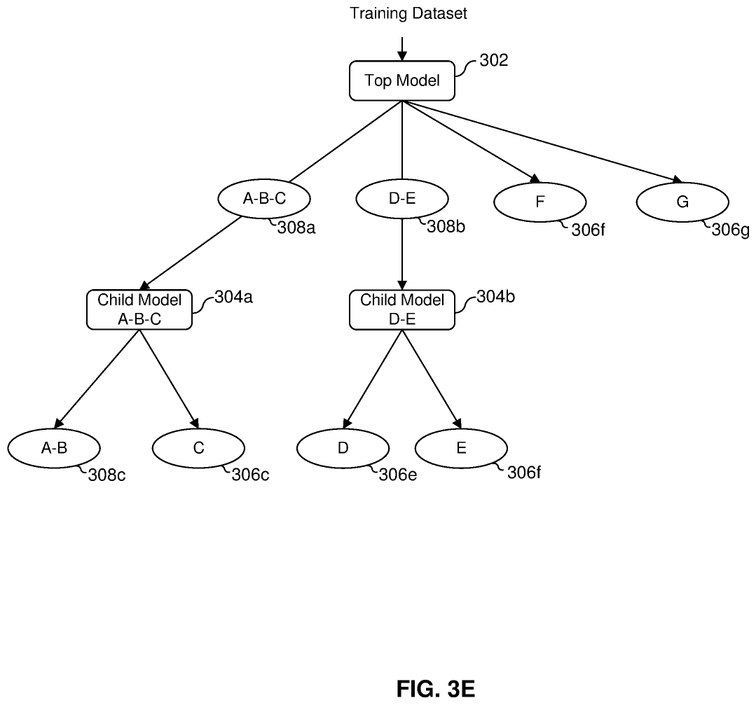

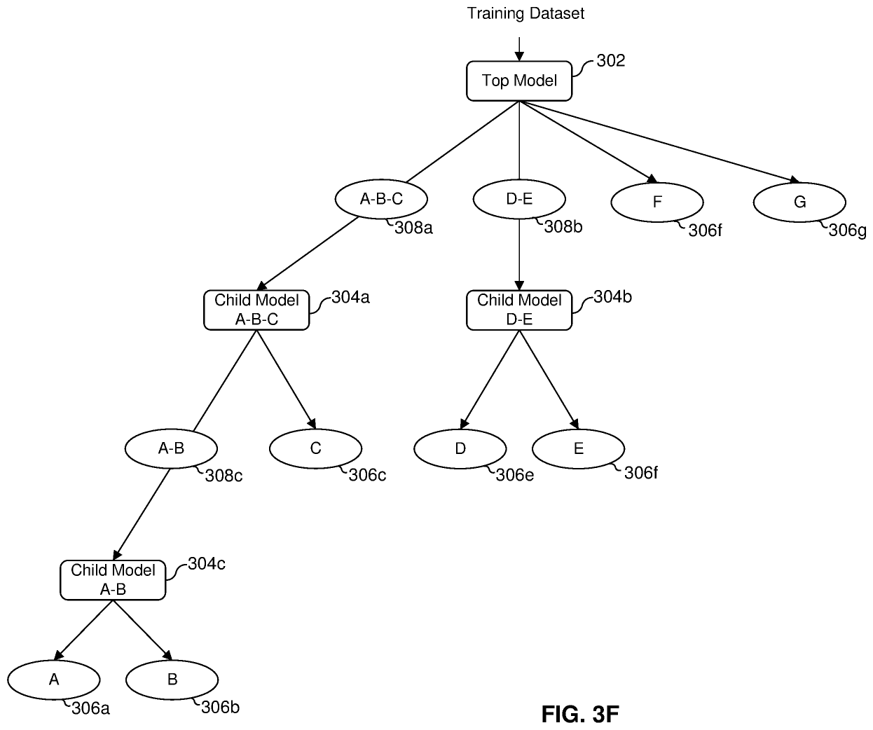

Classification system 102 may include a computing device, a computer, a server, a server cluster, a plurality of server clusters, and/or a cloud service, consistent with disclosed embodiments. Classification system 102 may include one or more memory units and one or more processors configured to perform operations consistent with disclosed embodiments. Classification system 102 may include computing systems configured to generate, receive, retrieve, store, and/or provide data models and/or datasets, consistent with disclosed embodiments. Classification system 102 may include computing systems configured to generate and train models, consistent with disclosed embodiments. Classification system 102 may be configured to receive data from, retrieve data from, and/or transmit data to other components of system 100 and/or computing components outside system 100 (e.g., via network 112). Classification system 102 is disclosed in greater detail below (in reference to FIG. 3).

Model storage 104 may be hosted on one or more servers, one or more clusters of servers, or one or more cloud services. Model storage 104 may be connected to network 112 (connection not shown). In some embodiments, model storage 104 may be a component of classification system 102 (not shown).

Model storage 104 may include one or more databases configured to store data models (e.g., machine-learning models or statistical models) and descriptive information of data models. Model storage 104 may be configured to provide information regarding available data models to a user or another system. Databases may include cloud-based databases, cloud-based buckets, or on-premises databases. The information may include model information, such as the type and/or purpose of a model and any measures of classification error. Model storage 104 may include one or more databases configured to store indexed and clustered models for use by classification system 100. For example, model storage 104 may store models associated with generalized representations of those models (e.g., neural network architectures stored in TENSORFLOW or other standardized formats).

Dataset database 106 may include one or more databases configured to store data for use by system 100, consistent with disclosed embodiments. In some embodiments, dataset database 106 may be configured to store datasets and/or one or more dataset indexes, consistent with disclosed embodiments. Dataset database 106 may include a cloud-based database (e.g., AMAZON WEB SERVICES RELATIONAL DATABASE SERVICE) or a non-premises database. Dataset database 106 may include datasets, model data (e.g., model parameters, training criteria, performance metrics, etc.), and/or other data, consistent with disclosed embodiments. Dataset database 106 may include data received from one or more components of system 100 and/or computing components outside system 100 (e.g., via network 112). In some embodiments, dataset database 106 may be a component of classification system 102 (not shown).

Remote database 108 may include one or more databases configured to store data for use by system 100, consistent with disclosed embodiments. Remote database 108 may be configured to store datasets and/or one or more dataset indexes, consistent with disclosed embodiments. Remote database 108 may include a cloud-based database (e.g., AMAZON WEBSERVICES RELATIONAL DATABASE SERVICE) or an on-premises database.

Client device 110 may include one or more memory units and one or more processors configured to perform operations consistent with disclosed embodiments. In some embodiments, client device 110 may include hardware, software, and/or firmware modules. Client device 110 may be a user device. Client device 110 may include a mobile device, a tablet, a personal computer, a terminal, a kiosk, a server, a server cluster, a cloud service, a storage device, a specialized device configured to perform methods according to disclosed embodiments, or the like.

At least one of classification system 102, model storage 104, dataset database 106, remote database 108, or client device 110 may be connected to network 112. Network 112 may be a public network or private network and may include, for example, a wired or wireless network, including, without limitation, a Local Area Network, a Wide Area Network, a Metropolitan Area Network, an IEEE 1002.11 wireless network (e.g., “Wi-Fi”), a network of networks (e.g., the Internet), a land-line telephone network, or the like. Network 112 may be connected to other networks (not depicted in FIG. 1) to connect the various system components to each other and/or to external systems or devices. In some embodiments, network 112 may be a secure network and require a password to access the network.

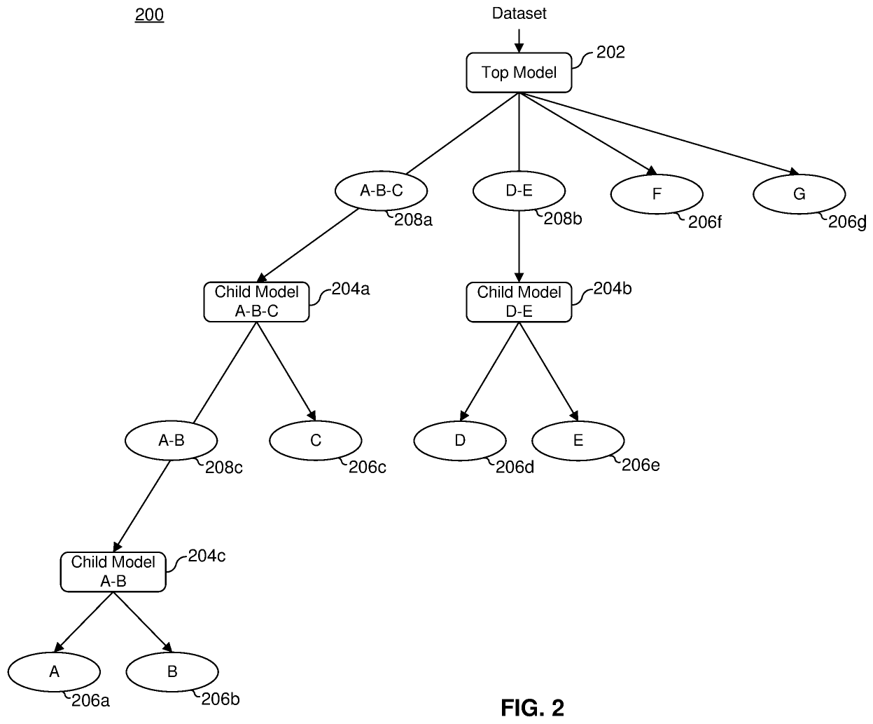

FIG. 2 depicts a hierarchical classification model 200, consistent with disclosed embodiments. Model 200 may include a plurality of tree nodes organized as a tree structure. As compared to conventional approaches, classifying data using model 200 may produce more accurate results with greater efficiency.

Generally, a tree structure may include a root node, a plurality of branch nodes (i.e., non-leaf nodes), and a plurality of leaf nodes. The root node may be a node that has no parent node but has one or more child nodes. Each of the child nodes of the root node may be a branch node or a leaf node. A branch node may be a node that has a parent node and one or more child nodes. The parent node of a branch node may be the root node or another branch node. Each of the child nodes of a branch node may be another branch node or a leaf node. A leaf node may be a node that has a parent node but no child nodes. The parent node of a leaf node may be a root node or a branch node.

In the embodiments of the present disclosure, the root node of the hierarchical classification model may correspond to a top-level classification model (hereinafter referred to as “top model”), which classifies input data of the hierarchical classification model. Each of the branch nodes of the hierarchical classification model may correspond to a child classification model (hereinafter referred to as “child model”) that further classifies the data initially classified by the top model. Each of the leaf nodes of the hierarchical classification model corresponds to a final classification result, which may be a “single category” or a “conjoined category”, which will be described in more detail below.

As shown in FIG. 2, hierarchical classification model 200 may include a top model 202 and a plurality of child models 204a, 204b, and 204c. Top model 202 may be configured to receive a dataset including a plurality of data elements. Top model 202 may be configured to classify the data elements within the received dataset into a plurality of categories, including conjoined category A-B-C 208a, conjoined category D-E 208b, single category F 206f, and single category G 206g. Child model A-B-C 204a may be configured to classify the data elements within conjoined category A-B-C 208a into a conjoined category A-B 208c and a single category C 206c. Child model D-E 204b may be configured to classify the data elements within conjoined category D-E 208b into a single category D 206d and a single category E 206e. Child model A-B 204c may be configured to classify the data elements within conjoined category A-B 208c into a single category A 206a and a single category B 206b.

In the present disclosure and the claims, the term “single category” refers to a category in which all data elements are of the same type. For example, a group of data elements may include images of different types of animals that belong to respective different single categories, such as a cat single category (category A), a dog single category (category B), a rat single category (category C), a fish single category (category D), a turtle single category (category E), a bird single category (category F), and an elephant single category (category G). In this example, all of the images in single category A 206a are images depicting cats; all of the images in single category B 206b depict images of dogs; and so on.

In the present disclosure and the claims, the term “conjoined category” refers to a group of data elements which includes data elements belonging to two or more single categories. The conjoined category is created because sometimes a classification model may have trouble accurately distinguishing between images or data elements within two or more single categories due to a similarity or likeness between features of the images or features of the data elements. A conjoined category may thus be formed by the hierarchical classification model 200 by combining two or more single categories resulted from a classification. The forming of the conjoined category will be described in more detail with reference to FIGS. 3A-3F.

In the above-described example of animal images, conjoined category A-B-C 208a may be referred to as a cat-dog-rat category that includes images within the cat single category, within the dog single category, and within the rat single category, based on the fact that all animals in conjoined category A-B-C 208a are small mammals. Similarly, conjoined category D-E 208b may be referred to as a fish-turtle category that includes images within the fish single category and within the turtle single category, based on the fact that each of the animals in the images within the fish-turtle category are associated with water.

While it may be relatively easy for a classification model to distinguish between a dog and a fish, or between a cat and a turtle, the classification model may sometimes be confused by images of a cat and a dog, or be confused by images of a fish and a turtle, due to similarity or likeness between the appearances of a cat and a dog, or similarity or likeness between the curved appearances of a fish and a turtle. Thus, the classification model may incorrectly classify a cat image as a dog, or classify a dog image as a cat. One attempt to avoid such misclassification may include repeatedly training a classification model using extensive data covering sufficiently large amount of categories until reaching accurate classification results across all of the categories, including the cat, dog, rat, fish, turtle, bird, and elephant categories. However, training and using such a classification model may require large amount of training data, long training time, and large computational resources.

In the embodiments of the present disclosure, top model 202 may be configured to classify an input dataset into a plurality of categories that are relatively easy to distinguish between each other, the plurality of categories including one or more conjoined categories and one or more single categories. As a result, training and using such a top model may be efficient and the classification result may be more accurate. Then, a child model may be configured to classify a corresponding conjoined category into (a) one or more single categories and/or (b) one or more single categories and one or more conjoined categories. Because the number of categories to which the data elements in the corresponding conjoined category belong is less than a total number of possible categories of the input dataset, training and using the child model may be efficient and the classification result may be more accurate.

In the embodiment depicted in FIG. 2, hierarchical classification model 200 includes only two levels of child models: a first level consisting of child models 204a and 204b, and a second level consisting of child model 204c. Indeed, a hierarchical classification model may include various levels of child models arranged in various tree structures. Thus, classifying data using such a hierarchical classification model may include iteratively classifying data by using a child model until a bottom of a tree structure is reached. The bottom of the tree structure is a child model that does not have any child (i.e., lower-level child model).

FIGS. 3A-3F depict a method for creating a hierarchical classification model, consistent with disclosed embodiments. As shown in FIG. 3A, the method may include inputting a training dataset into a top model 302 and training the top model 302 to classify the training dataset based on the set of possible categories.

The training dataset may include any kind of data (e.g., text data, image data, numeric data, time series data, etc.). The training dataset may include multi-dimensional data and may be organized according to various data schemas. An example of a multi-dimensional dataset is a set of temperature values of multiple reporting stations over periods of time. The training dataset may include a plurality of data samples (e.g., a plurality of image files, a plurality of video files, a plurality text files, a plurality of data columns). Each of the data samples in the training dataset may be associated with a “true label” (as contrasted with a “predicted label,” described below) representing a category to which the data sample actually belongs. For example, the data samples in the training dataset may be a plurality of animal images, including images of cats, dogs, rats, fish, turtles, birds, and elephants. Each animal image may be associated with a true label representing a category (cat, dog, rat, fish, turtle, bird, and elephant) to which the animal belongs.

Top model 302 may determine a set of possible categories based on the training dataset. The set of possible categories may include categories to which the data samples within the training dataset belong. For example, when the data samples include images of cats, dogs, rats, fish, turtles, birds, and elephants, the set of possible categories may include a cat category (category A), a dog category (category B), a rat category (category C), a fish category (category D), a turtle category (category E), a bird category (category F), and an elephant category (category G).

Top model 302 may be any classification model that can be trained to classify the data samples within the training dataset based on the set of possible categories. Top model 302 may output, as a result, the data samples of the training dataset grouped into predicted categories, such as category A 306a, category B 306b, category C 306c, category D 306d, category E 306e, category F 306f, and category G 306g. Top model 302 may also output predicted labels for the data samples within the training dataset. Each predicted label may represent the predicted category for a respective one of the data samples.

After top model 302 classifies the training dataset based on the set of possible categories, the classification result may be analyzed. The analysis may be performed either manually by a user or automatically by a computer (e.g., classification system 102). For example, top model 302 may output performance data representing a level of performance of the classifying by top model 302, and the user or the computer may analyze the performance data. For example, the performance data may include a confusion matrix generated based on the true labels and the predicted labels of the data samples. Additionally, or alternatively, the performance data may include a confidence level associated with each of the predicted labels. In another alternative, the performance data may include a precision-recall curve, a receiver operating characteristic curve (ROC) curve, or an area under the precision-recall curve or the ROC curve, associated with each of the predicted labels.

The performance data may be analyzed to determine whether there are some categories that are similar to each other to the extent that they may be confused with each other by top model 302. If there are some categories that are confused with each other, the categories may be combined together to form a conjoined category.

In some embodiments, the computer or the user may analyze a “confusion matrix” output from top model 302 to determine whether or not to form one or more conjoined categories. In general, a confusion matrix may be an N×N matrix (where N is the number of categories) in which the vertical axis represents the true labels of the data elements in a training dataset, and the horizontal axis represents the predicted labels of the data elements predicted by top model 302. Each element (i, j) in the matrix represent the number of data samples with a true label i that were classified as having the predicted label j. Thus, the confusion matrix may provide information regarding which category is commonly misclassified as one or more other categories, and the number of such misclassifications.

In the embodiments of the present disclosure, when the computer or the user determines, based on the confusion matrix output from top model 302, that the numbers or percentages of the misclassifications among a subset of categories predicted by top model 302 reach a threshold value, the computer or the user may combine the subset of categories that are being misclassified to form a conjoined category. For example, with reference to FIG. 3A, based on a confusion matrix, one may observe that there are X percent of fish images (category D) incorrectly classified as turtle images (category E), and there are Y percent of turtle images (category E) incorrectly classified as fish images (category D). When the percentages of misclassifications between the fish category (category D) and the turtle category (category E) reach a threshold percentage value, one may determine that the fish category (category D) and the turtle category (category E) are confused with each other. As a result, the fish category (category D) and the turtle category (category E) may be combined to generate a conjoined category, i.e., a fish-turtle category (conjoined category D-E).

In some examples, the computer or the user may determine, based on the confusion matrix output from top model, that misclassifications occur among three, or more than three, categories at a percentage above a threshold percentage value. In such case, one may determine to combine all of the categories that are being misclassified to form a conjoined category. For example, with reference to FIG. 3A, one may observe that misclassification occurs among the cat category (category A), the dog category (category B), and the rat category (category C). As a result, the cat category (category A), the dog category (category B), and the rat category (category C) may be combined to generate a cat-dog-rat category (conjoined category A-B-C).

Additionally, in some examples, the computer or the user may determine, based on the confusion matrix output from top model, that misclassifications occur in two or more subsets of categories. In such case, one may determine to generate two or more conjoined categories, each conjoined category corresponding to one subset of categories that are being misclassified. For example, with reference to FIG. 3A, one may observe that misclassifications occur in a first subset of possible categories including the cat category (category A), the dog category (category B), and the rat category (category C), and a second subset of possible categories including the fish category (category D) and turtle category (category E). As a result, the cat category (category A), the dog category (category B), and the rat category (category C) may be combined to generate a cat-dog-rat category (conjoined category A-B-C), and the fish category (category D) and turtle category (category E) may be combined to generate a fish turtle category (conjoined category D-E).

In some embodiments, the computer or the user may analyze the confidence levels output from top model 302 to determine whether or not to generate one or more conjoined categories. When confidence levels of some predicted labels are very close to each other, the categories associated with these predicted labels may be combined to generate a conjoined category. For example, when the confidence levels of some predicted labels are below a threshold confidence level, and the confidence levels are similar to each other (e.g., the difference between the confidence levels is below a threshold difference value), one may determine to generate a conjoined category combining the categories associated with the predicted labels. For example, when classifying images of animals such as cat, dog, rat, fish, turtle, etc., some predicted cat labels may have confidence levels of around 33%, and some predicted dog labels may have confidence levels of around 34%, and some predicted rat labels may have confidence levels of around 33%. In this case, one may determine to generate a conjoined cat-dog-rat category.

In some embodiments, the computer or the user may analyze the area under the precision-recall curve or the ROC curve (area under curve “AUC”), associated with each of the predicted labels, to determine whether or not to generate one or more conjoined categories. Generally, the precision-recall curve or the ROC curve is calculated for each of the predicted label against the rest of the predicted label. An area under the precision-recall curve or the ROC curve associated with a predicted label may represent how well a prediction is for the predicted label. Thus, when the areas of some predicted labels are below a threshold confidence level, one may determine that the prediction for these labels are suboptimal. Thus, a conjoined category may be generated by combining the categories associated with these predicted labels.

After generating one or more conjoined categories, the set of possible categories may be updated based on the conjoined categories, and top model 302 may be re-trained to classify the training dataset based on the updated set of possible categories. The updating of the set of possible categories may be performed in two different methods.

In a first method consistent with the disclosed embodiments, the set of possible categories may be updated to add the one or more conjoined category, and delete the single categories that form the conjoined categories. For example, as depicted in FIG. 3B, once conjoined categories A-B-C and D-E are generated, the original set of possible categories (which included categories A through G) may be updated to add conjoined categories A-B-C and D-E, and to delete the single categories A, B, C, D, and E. As a result, the updated set of possible categories may include categories A-B-C, D-E, F, and G. Afterwards, top model 302 may be re-trained to classify the training dataset based on the updated set of possible categories A-B-C, D-E, F, and G, and output a plurality of predicted categories, including category A-B-C 308a, category C-D 308b, category F 306f, and category G 306g.

In a second method consistent with the disclosed embodiments, the set of possible categories may be updated to simply add the conjoined category. For example, as depicted in FIG. 3C, the original set of possible categories including categories A through G may be updated to add conjoined categories A-B-C and D-E. As a result, the updated set of possible categories may include categories A-B-C, D-E, A, B, C, D, E, F, and G. Afterwards, top model 302 may be re-trained to classify the training dataset based on the updated set of possible categories A-B-C, D-E, A, B, C, D, E, F, and G, and output a plurality of predicted categories, including category A-B-C 308a, category D-E 308b, category A 306a, category B 306b, category C 306c, category D 306d, category E 306e, category F 306f, and category G 306g.

The following description will be provided for steps performed after updating the set of possible categories using the first method and outputting category A-B-C 308a, category C-D 308b, category F 306f, and category G 306g. It should be understood that the steps performed after updating the set of possible categories using the second method will be similar to the steps performed after the first method, and thus detailed description of the steps performed after updating the set of possible categories using the second method is not repeated.

As shown in FIG. 3D, after top model 302 classifies the training dataset based on the updated set of possible categories in FIG. 3B, child model A-B-C 304a and child model D-E 304b may be generated for conjoined category A-B-C 308a and conjoined category D-E 308b, respectively. Child model A-B-C 304a may be trained to classify the data samples within the conjoined category A-B-C 308a based on a subset of possible categories associated with child model A-B-C 304a; and child model D-E 304b may be trained to classify the data samples in the conjoined category D-E 308b based on a subset of possible categories associated with child model D-E 304b. The subset of possible categories associated with a child model may include the single categories that were joined by a conjoined category for which the child model is generated. Thus, the subset of possible categories associated with child model A-B-C 304a may include categories A, B, and C, and the subset of possible categories associated with child model D-E 304b may include categories D and E. As a result of the classifying by child models 304a and 304b, child model A-B-C 304a may output a plurality of predicted categories including category A 306a, category B 306b, and category C 306c, and child model D-E 304b may output a plurality of predicted categories including category D 306d and category E 306e. Each predicted category may include one or more data samples that are classified by respective child model 304a or 304b.

In this manner, each child model 304a or 304b may be trained to consider more feature parameters in order to distinguish between the single categories, for example, between category A (cat), category B (dog), and category C (rat), or between category D (fish) and category E (turtle). As a result, the classification result obtained by each child model 304a or 304b may be more accurate than the classification result obtained by the original top model 302.

In some embodiments, a child model may be trained by using the data samples in the corresponding conjoined category. For example, child model A-B-C 304a may be trained using the data samples in conjoined category A-B-C 308a.

In some alternative embodiments, a clustering algorithm may be employed to gather more data samples that are potentially predicted correctly but are similar to the corresponding conjoined category, to train a child model. For example, once conjoined category A-B-C 308 is generated based on a confusion matrix, confidence levels, etc., a clustering algorithm may be applied to data samples in conjoined category A-B-C 308, to generate a plurality of clusters. Each cluster may have a clustering center (in terms of confidence vector, feature value, etc.). Then, a subset of data samples (that belong to single categories A 306a, B 306b, and C 306c and are similar to the data samples within the clusters) may be selected. For example, a data sample within single category A 306a, B 306b, or C 306c may be selected when a distance (in terms of confidence vector, feature value, etc.) between the data sample and a clustering center is less than a threshold distance. The selected subset of data samples may be used together with the data samples within conjoined category A-B-C 308 to train child model A-B-C 304a.

In another example, once conjoined category A-B-C 308 is generated, a clustering algorithm may be applied to data samples within all of conjoined category A-B-C 308, and single categories A 306a, B 306b, and C 306c, to generate a plurality of clusters. Next, a confusion rate may be calculated for each of the clusters. The confusion rate of a cluster may be calculated based on a combination of the confidence levels of all of the data samples within the cluster. Then, the data samples within the clusters having relatively high confusion rates (e.g., higher than a threshold confusion rate) may be used to train child model A-B-C 304a in addition to the data samples in conjoined category A-B-C 308.

In the embodiment depicted in FIG. 3D, top model 302 outputs only two conjoined categories, i.e., conjoined category A-B-C 308a and conjoined category D-E 308b, and thus only two child models 304a and 304b are generated to classify the data within conjoined category A-B-C 308a and conjoined category D-E 308b. In some alternative embodiments, top model 302 may output more than two conjoined categories. In this case, more than two child models may be generated to classifying data in the more than two conjoined categories, respectively.

After child models 304a and 304b classify data and output predicted categories A through E, the classification result may be analyzed by a user or a computer to determine whether a performance criterion is satisfied. For example, a confusion matrix may be generated based on the result of the classifying by child models 304a and 304b, and the user or the computer may determine whether there are still some confusions or misclassifications between the categories predicted by child models 304a and 304b. If the number or the percentage of the misclassifications among a subset of categories predicted by child model 304a or 304b is below a threshold value, one may determine that the performance criterion is satisfied. For another example, child models 304a and 304b may output predicted labels and their associated confidence levels for the data samples. If the confidence levels are above a threshold confidence level, the user or the computer may determine that the performance criterion is satisfied. For still another example, child models 304a and 304b may output predicted labels and their associated precision-recall curves, or ROC curves, and areas under the precision-recall curves or the ROC curves. If the areas are above a threshold area, the user or the computer may determine that the performance criterion is satisfied.

When the performance criterion is satisfied, the process of creating the hierarchical classification model may be completed. In this case, the final hierarchical classification model may be the one depicted in FIG. 3D, which includes top model 302 as a root node of a tree structure, child model A-B-C 304a and child model D-E 304b as branch nodes of the tree structure, and categories A through E 306a to 306g as leaf nodes of the three structure.

As shown in FIG. 3E, when the performance criterion is not satisfied, the user or the computer may analyze the result of the classifying by child models 304a and 304b to determine which categories are confused with each other. Then, the confused categories may be combined together to form a lower-level conjoined category. The method of determining confusion between the categories output from child models 304a and 304b may be similar as the method of determining confusion between the categories output from top model 302. Therefore, detailed description thereof is not repeated. In the example depicted in FIG. 3E, it may be determined that category A (cat) and category B (dog) are confused with each other. As a result, category A and category B may be combined to generate a conjoined category A-B 308C (cat-dog category).

After the conjoined category A-B is generated, the subset of possible categories associated with child model A-B-C 304a may be updated with the conjoined category A-B, and child model A-B-C 304a may be re-trained to classify the data samples within conjoined category A-B-C 308a based on the updated subset of possible categories associated with child model A-B-C 304a. In the example depicted in FIG. 3E, the possible categories associated with child model A-B-C 304a may be updated by adding the conjoined category A-B and deleting the single categories A and B that were combined by the conjoined category A-B. As a result, the possible categories associated with the child model A-B-C 304a may include the conjoined category A-B and the single category C. Afterwards, child model A-B-C 304a may be re-trained to classify the data samples within conjoined category A-B-C 308a based on the updated set of possible categories A-B and C, and output predicated categories including category A-B 308c and category C 306c.

As shown in FIG. 3F, after child model A-B-C 304a classifies the data samples within conjoined category A-B-C 308a and outputs predicated categories including category A-B 308c and category C 306c, a lower-level child model A-B 304c may be generated and trained to classify the data samples within conjoined category A-B 308c based on a set of possible categories associated with child model 304. The possible categories associated with child model 304 may include category A and category B. As a result of the classifying by child model A-B 304c, child model A-B 304c may output predicted categories including category A 306a and category B 306b.

In the embodiment depicted in FIG. 3F, there are only two levels of child models, a first level consisting of child models 304a and 304b, and a second level consisting of child model 304c. In some other embodiments, more than two levels of child models may be generated. The number of the levels of child models may be determined based on the dataset, and the performance of the classification models. When it is determined that a lower-level conjoined category needs to be generated based on a result of classifying by child model, the set of possible categories associated with the child model may be updated based on the lower-level conjoined category, and the child model may be re-trained to classify data based on the updated set of possible categories. Then, a lower-level child model may be generated to classify data in the lower-level conjoined category. The process of generating a conjoined category and then generating a child model to classify data in the conjoined category may be repeated until no further conjoined category is required to be formed (e.g., the child model outputs only two single categories such as child model 304c in FIG. 3F, or there is no more confusion between the single categories output by the child model such as child model 304a in FIG. 3D, or further generating a conjoined category would not improve the accuracy of the classification such as child model 304a in FIG. 3E, etc.).

In some embodiments, the process of generating the hierarchical classification model may be completed at the example depicted in FIG. 3F, i.e., when the lowest-level child model A-B 304c outputs two single categories A and B 306a and 306b. In this case, the final hierarchical classification model may be the one depicted in FIG. 3F, which includes top model 302 as a root node of a tree structure, child models 304a, 304b, and 304c as branch nodes of the tree structure, and predicted categories 306a through 306g as leaf nodes of the tree structure.

In some alternative embodiments, the classification result of child mode 304c may be evaluated to determine whether a stopping condition is met. The stopping condition is met when the performance of the classifying by child model A-B 304c does not improve over a previous classification by a parent node of child model A-B 304c. In the embodiment depicted in FIG. 3F, the parent node of child model A-B 304c is child model A-B-C 304a. Thus, it is determined whether the performance of the classifying by child model A-B 304c improves over the previous classification by child model A-B-C 304a as depicted in FIG. 3D, which classifies data into categories A, B, and C.

For example, the numbers of misclassifications in category A 306a and category B 306b output from child model A-B 304c in FIG. 3F may be compared with the numbers of misclassifications in category A 306a and category B 306b output from child model A-B-C 304a in FIG. 3D. If the numbers or percentages of misclassifications in category A 306a and category B 306b in FIG. 3F are not reduced compared to the ones in FIG. 3D, or the numbers or percentages of misclassifications are reduced but the amount of reduction does not reach a threshold reduction level, then it is determined that the classifying by child model A-B 304c does not improve a final result.

In another example, performance metrics (e.g., the confidence levels, f1 scores, or areas under precision-recall curves or the ROC curves associated) of data samples in category A 306a and category B 306b output from child model A-B 304c in FIG. 3F may be compared with the ones in category A 306a and category B 306b output from child model A-B-C 304a (before the set of possible categories associated with child model A-B-C 304a is updated, as depicted in FIG. 3D). If the performance metrics do not increase, or the level of improvement does not reach a threshold value, it is determined that the classifying by child model A-B 304c does not improve the final result.

When it is determined that the classifying by child model A-B 304c does not improve the final result over the previous classification by child model A-B-C 304a, the stopping condition is met. In this case, child model A-B 304c may be deleted from the hierarchical classification model. Thus, the final hierarchical classification model may be the one depicted in FIGS. 3D or 3E. In FIG. 3E, child model A-B-C 304a may be configured to classify data in conjoined category A-B-C 308a into conjoined category A-B 308c and category C 306c. Additionally, child model A-B-C 304a may be configured to output a predicted label for each data samples in conjoined category A-B 308c as the final classification result. The predicted label indicates that data samples in conjoined category A-B 308c may not be further classified. Therefore, the final hierarchical classification model depicted in FIG. 3E may include top model 302 as a root node of a tree structure, child models 304a and 304b as branch nodes of the tree structure, and predicted categories 308c and 306c-306g as leaf nodes of the tree structure. Alternatively, when it is determined that the classifying by child model A-B 304c does not improve the final result, the final hierarchical classification model may be the one depicted in FIG. 3D, which may include top model 302 as a root node of a tree structure, child model A-B-C 304a and child model D-E 304b as branch nodes of the tree structure, and categories A through E 306a to 306g as leaf nodes of the three structure.

When it is determined that the classifying by child model A-B 304c improves the final result over the previous classification by child model A-B-C 304a, the stopping condition is not met. In this case, the final hierarchical classification model may be the one depicted in FIG. 3F, which includes top model 302 as a root node of a tree structure, child models 304a, 304b, and 304c as branch nodes of the tree structure, and predicted categories 306a-306g as leaf nodes of the tree structure.

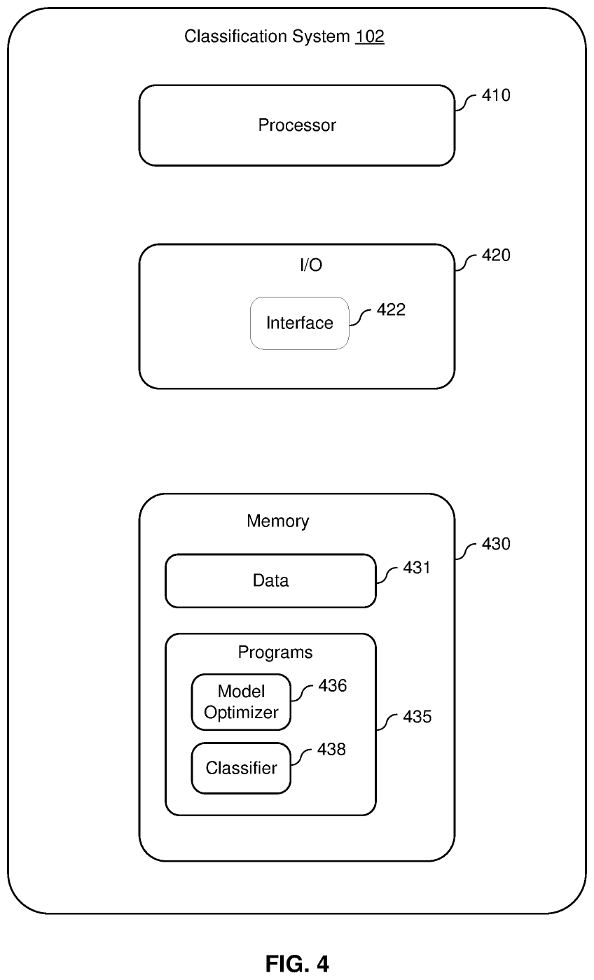

FIG. 4 depicts exemplary classification system 102, consistent with disclosed embodiments. Classification system 102 may include a computing device, a computer, a server, a server cluster, a plurality of clusters, and/or a cloud service, consistent with disclosed embodiments. As shown, classification system 102 may include one or more processors 410, one or more I/O devices 420, and one or more memory units 430. In some embodiments, some or all components of classification system 102 may be hosted on a device, a computer, a server, a cluster of servers, or a cloud service. In some embodiments, classification system 102 may be a scalable system configured to efficiently manage resources and enhance security by provisioning computing resources in response to triggering events and terminating resources after completing a task (e.g., a scalable cloud service that spins up and terminates container instances).

FIG. 4 depicts an exemplary configuration of classification system 102. As will be appreciated by one skilled in the art, the components and arrangement of components included in classification system 102 may vary. For example, as compared to the depiction in FIG. 4, classification system 102 may include a larger or smaller number of processors, I/O devices, or memory units. In addition, classification system 102 may further include other components or devices not depicted that perform or assist in the performance of one or more processes consistent with the disclosed embodiments. The components and arrangements shown in FIG. 4 are not intended to limit the disclosed embodiments, as the components used to implement the disclosed processes and features may vary.

Processor 410 may comprise known computing processors, including a microprocessor. Processor 410 may constitute a single-core or multiple-core processor that executes parallel processes simultaneously. For example, processor 410 may be a single-core processor configured with virtual processing technologies. In some embodiments, processor 410 may use logical processors to simultaneously execute and control multiple processes. Processor 410 may implement virtual machine technologies, or other known technologies to provide the ability to execute, control, run, manipulate, store, etc., multiple software processes, applications, programs, etc. In another embodiment, processor 410 may include a multiple-core processor arrangement (e.g., dual core, quad core, etc.) configured to provide parallel processing functionalities to allow execution of multiple processes simultaneously. One of ordinary skill in the art would understand that other types of processor arrangements could be implemented that provide for the capabilities disclosed herein. The disclosed embodiments are not limited to any type of processor. Processor 410 may execute various instructions stored in memory 430 to perform various functions of the disclosed embodiments described in greater detail below. Processor 410 may be configured to execute functions written in one or more known programming languages.

I/O devices 420 may include at least one of a display, an LED, a router, a touchscreen, a keyboard, a microphone, a speaker, a haptic device, a camera, a button, a dial, a switch, a knob, a transceiver, an input device, an output device, or another I/O device to perform methods of the disclosed embodiments. I/O devices 420 may be components of an interface 422 (e.g., a user interface).

Interface 422 may be configured to manage interactions between system 100 and other systems using network 112. In some aspects, interface 422 may be configured to publish data received from other components of system 100. This data may be published in a publication and subscription framework (e.g., using APACHE KAFKA), through a network socket, in response to queries from other systems, or using other known methods. Data may be synthetic data, as described herein. As an additional example, interface 422 may be configured to provide information received from other components of system 100 regarding datasets. In various aspects, interface 422 may be configured to provide data or instructions received from other systems to components of system 100. For example, interface 422 may be configured to receive instructions for generating data models (e.g., type of data model, data model parameters, training data indicators, training parameters, or the like) from another system and provide this information to programs 435. As an additional example, interface 422 may be configured to receive data including sensitive data from another system (e.g., in a file, a message in a publication and subscription framework, a network socket, or the like) and provide that data to programs 435 or store that data in, for example, data 431, model storage 104, dataset database 106, and/or remote database 108.

In some embodiments, interface 422 may include a user interface configured to receive user inputs and provide data to a user (e.g., a data manager). For example, interface 422 may include a display, a microphone, a speaker, a keyboard, a mouse, a track pad, a button, a dial, a knob, a printer, a light, an LED, a haptic feedback device, a touchscreen and/or other input or output devices.

Memory 430 may be a volatile or non-volatile, magnetic, semiconductor, optical, removable, non-removable, or other type of storage device or tangible (i.e., non-transitory) computer-readable medium, consistent with disclosed embodiments. As shown, memory 430 may include data 431, including one of at least one of encrypted data or unencrypted data. Consistent with disclosed embodiments, data 431 may include datasets, model data (e.g., model parameters, training criteria, performance metrics, etc.), and/or other data.

Programs 435 may include one or more programs (e.g., modules, code, scripts, or functions) used to perform methods consistent with disclosed embodiments. Programs may include operating systems (not shown) that perform known operating system functions when executed by one or more processors. Disclosed embodiments may operate and function with computer systems running any type of operating system. Programs 435 may be written in one or more programming or scripting languages. One or more of such software sections or modules of memory 430 may be integrated into a computer system, non-transitory computer-readable media, or existing communications software. Programs 435 may also be implemented or replicated as firmware or circuit logic.

Programs 435 may include a model optimizer 436 and a classifier 438, and/or other components (e.g., modules) not depicted to perform methods of the disclosed embodiments. In some embodiments, modules of programs 435 may be configured to generate (“spin up”) one or more ephemeral container instances (e.g., an AMAZON LAMBDA instance) to perform a task and/or to assign a task to a running (warm) container instance, consistent with disclosed embodiments. Modules of programs 435 may be configured to receive, retrieve, and/or generate models, consistent with disclosed embodiments. Modules of programs 435 may be configured to perform operations in coordination with one another. In some embodiments, programs 435 may be configured to conduct an authentication process, consistent with disclosed embodiments.

Model optimizer 436 may include programs (e.g., scripts, functions, algorithms) to train, implement, store, receive, retrieve, and/or transmit one or more machine-learning models. Machine-learning models may include a neural network model, an attention network model, a generative adversarial model (GAN), a recurrent neural network (RNN) model, a deep learning model (e.g., a long short-term memory (LSTM) model), a random forest model, a convolutional neural network (CNN) model, an RNN-CNN model, an LSTM-CNN model, a temporal-CNN model, a support vector machine(SVM) model, a Density-based spatial clustering of applications with noise (DBSCAN) model, a k-means clustering model, a distribution-based clustering model, a k-medoids model, a natural-language model, and/or another machine-learning model. Models may include an ensemble model (i.e., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. Model optimizer 436 may be configured to adjust model parameters during training. Model parameters may include weights, coefficients, offsets, or the like. Training may be supervised or unsupervised.

Model optimizer 436 may be configured to train machine-learning models by optimizing model parameters and/or hyperparameters (i.e., hyperparameter tuning) using an optimization technique, consistent with disclosed embodiments. Hyperparameters may include training hyperparameters, which may affect how training of a model occurs, or architectural hyperparameters, which may affect the structure of a model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. Model optimizer 436 may be configured to optimize statistical models using known optimization techniques.

In some embodiments, model optimizer 436 may be configured to generate models based on instructions received from another component of system 100 and/or a computing component outside system 100 (e.g., via interface 422, from client device 110, etc.). For example, model optimizer 436 may be configured to receive a visual (e.g., graphical) depiction of a machine-learning model and parse that graphical depiction into instructions for creating and training a corresponding neural network. Model optimizer 436 may be configured to select model-training parameters. This selection can be based on model performance feedback received from another component of system 100. Model optimizer 436 may be configured to provide trained models and descriptive information concerning the trained models to model storage 104.

Model optimizer 436 may be configured to train data models to generate synthetic data based on an input dataset (e.g., a dataset comprising actual data). For example, model optimizer 436 may be configured to train data models to generate synthetic data. Synthetic data may be generated to replace sensitive information identified in a dataset. In some embodiments, model optimizer 436 may be configured to train data models to generate synthetic data based on a data profile (e.g., a data schema and/or a statistical profile of a dataset). For example, model optimizer 436 may be configured to train data models to generate synthetic data to satisfy a performance criterion. Performance criteria may be based on a similarity metric representing a measure of similarity between a synthetic dataset and another dataset.

Classifier 438 may include programs (e.g., scripts, functions, algorithms) to encode data, to classify data, and/or to cluster data, consistent with disclosed embodiments. Classifier 438 may include any classification model as described herein. Classification models may comprise machine-learning models configured to classify data. For example, a classification model may include a natural-language processing model, a binary classification model, a convolutional neural network model, a deep-learning model, a Bidirectional Encoder Representations from Transformers (BERT) model, an Embeddings from Language Models (ELMo) representation model, or any other model configured to classify data.

Classifier 438 may include programs to transform string data (e.g., character data or other non-numeric data) into numeric data (e.g., to transform letters, words, or other strings into numbers according to a table). Classifier 438 may be configured to perform methods of character encoding (e.g., one-hot encoding). In some embodiments, classifier 438 may be configured to receive, train, and/or implement a machine-learning model configured for natural-language processing (i.e., a natural-language model). In some embodiments, classifier 438 may be configured to implement a natural-language model to encode string data as numeric data. For example, classifier 438 may transform words and/or phrases into numbers by applying a lexicon, a parser, and a grammar rule system. In some embodiments, classifier 438 may be configured to receive, train, and/or implement an autoencoder model or components of an autoencoder model (e.g., an encoder model or a decoder model). In some embodiments, classifier 438 may be configured to implement an auto encoder model to reduce the dimensionality of a dataset. Classifier 438 may be configured to tag classified and/or clustered data, consistent with disclosed embodiments.

Classifier 438 may include programs configured to classify data by analyzing properties of data and/or data models. For example, classifier 438 may include or be configured to implement one or more data-profiling models. A data-profiling model may include machine-learning models and statistical models to determine a data schema and/or a statistical profile of a dataset (i.e., to profile a dataset), consistent with disclosed embodiments. A data-profiling model may include an RNN model, a CNN model, or other machine-learning model.

Classifier 438 may include algorithms to determine a data type, key-value pairs, row-column data structure, statistical distributions of information such as keys or values, or other property of a data schema may be configured to return a statistical profile of a dataset (e.g., using a data-profiling model). For example, classifier 438 may classify data elements in a dataset according to their data types. Classifier 438 may also be used to classify values of data elements in a dataset as keys to the data elements to get a key-value pair for each data elements. Classifier 438 may further determine classification of a column in a dataset with row-column data structure by using statistics information of the dataset. A data-profiling model may use statistics information of a dataset to classify the data elements in the dataset. In some embodiments, classifier 438 may be configured to implement univariate and multivariate statistical methods. Classifier 438 may include a regression model, a Bayesian model, a statistical model, a linear discriminant analysis model, or other classification model configured to determine one or more descriptive metrics of a dataset. For example, classifier 438 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

In some embodiments, classifier 438 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, classifier 438 may be configured to generate a similarity metric representing a measure of similarity between data in a dataset. A similarity metric maybe based on a correlation, covariance matrix, a variance, a frequency of overlapping values, or other measure of statistical similarity.

In some embodiments, classifier 438 may be configured to classify data. For example, classifier 438 may classify data into a plurality of categories which include one or more single categories and/or one or more conjoined categories. As described previously, a single category may include data elements of the same type (e.g., a cat single category, a dog single category, etc.), and a conjoined category may include data elements belong to two or more single categories (e.g., a cat-dog category, etc.). Classifying data may include determining whether a data sample is related to another data sample. Classifying a dataset may include clustering datasets and generating information indicating whether a dataset belongs to a cluster of datasets. In some embodiments, classifying a dataset may include generating data describing a dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as a node diagram, a tree diagram, or a vector diagram of datasets. Classifying a dataset may include estimating a likelihood that a dataset relates to another dataset, the likelihood being based on the similarity metric.

Classifier 438 may be configured to classify a dataset based on data-model output, consistent with disclosed embodiments. For example, classifier 438 may be configured to classify a dataset based on a statistical profile of a distribution of activation function values. In some embodiments, classifier 438 may be configured to classify a dataset at least one of an edge, a foreign key, a data schema, or a similarity metric, consistent with disclosed embodiments. In some embodiments, the similarity metric represents a statistical similarity between data-model output of a first dataset and a second dataset, consistent with disclosed embodiments. As another example, classifier 438 may classify a dataset as a related dataset based on determination that a similarity metric between a dataset and a previously classified dataset satisfies a criterion.

Classifier 438 may include programs to encode data, to classify data, and/or to cluster data based on output of data classification models and/or data clustering models (i.e., based on preliminary clustered data). Classifier 438 may be configured to receive, generate, train, and/or implement a hierarchical classification model including a top classification model and a plurality of child classification models, consistent with disclosed embodiments. Each one of the top classification models and the plurality of child classification models may include a machine-learning model. For example, a classification model may include a deep learning model, a neural network model, an RNN, a CNN, a random forest model, a Support Vector Machine (SVM) model, a Density-based spatial clustering of applications with noise (DBSCAN) model, a k-means clustering model, a distribution-based clustering model, a k-medoids model, and/or any other type of machine-learning model. Each child classification model may be trained to classify data based on classification result of a parent classification model, which may be the top model or an upper-level child model.

In some embodiments, a hierarchical classification model may be configured to determine a performance metric of the top classification model and the plurality of child classification models. In some embodiments, a hierarchical classification model may be repeatedly updated or trained until the performance metrics of the top classification model and the plurality of child classification models are satisfied.

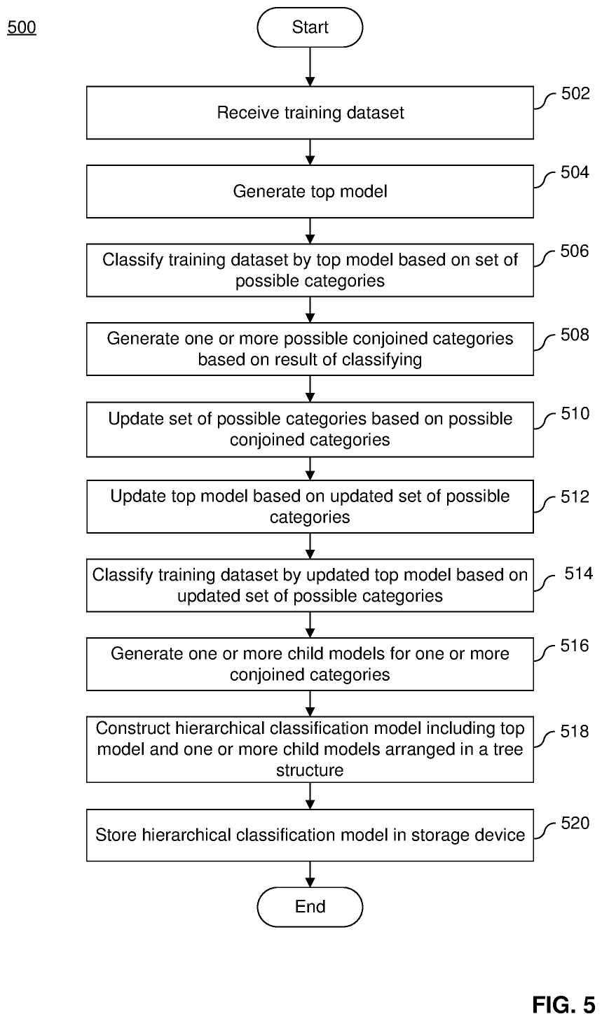

FIG. 5 depicts exemplary process 500 for generating a hierarchical classification model to classify data, consistent with disclosed embodiments. In some embodiments, classification system 102 may perform process 500 using programs 435. One or more of model optimizer 436 or classifier 438, and/or other components of programs 435 may perform operations of process 500, consistent with disclosed embodiments. It should be noted that other components of system 100, including, for example, client device 110 may perform operations of one or more steps of process 500.

Consistent with disclosed embodiments, steps of process 500 may be performed on one or more cloud services using one or more ephemeral container instances (e.g., AMAZON LAMBDA). For example, at any of the steps of process 500, classification system 102 may generate (spin up) an ephemeral container instance to execute a task, assign a task to an already-running ephemeral container instance (warm container instance), or terminate a container instance upon completion of a task. As one of skill in the art will appreciate, steps of process 500 may be performed as part of an application interface (API) call.

At step 502, classification system 102 may receive a training dataset, consistent with disclosed embodiments. In some embodiments, step 502 may include receiving the training dataset from data 431, one or more client devices (e.g., client device 110), dataset database 106, remote database 108, and/or a computing component outside system 100. Step 502 may include retrieving the training dataset from a data storage (e.g., from data 431, dataset database 106, and/or remote database 108).

The training dataset may include a plurality of data samples. The data samples may be any of the types of data previously described or any other type of dataset. The data samples may involve time series data, numeric data, text data, and/or image data. For example, the training dataset may include personal data, transaction data, financial data, demographic data, public data, government data, environmental data, traffic data, network data, transcripts of video data, genomic data, proteomic data, and/or other data. The data samples in the training dataset may have a range of dimensions, formats, data schema, and/or statistical profiles. For example, the data samples may include time series data with dimensions corresponding to longitude, latitude, cancer incidence, population density, air quality, and water quality. Each of the data samples in the training dataset may be associated with a true label representing a category to which the data sample belongs.

Additionally, at step 502, classification system 102 may determine a set of possible categories by analyzing the statistical profile or the true labels associated with the data samples within the training dataset. The set of possible categories may include categories to which the data samples within the training dataset belong. For example, when the data samples include cat images, dog images, rat images, and fish images, the set of possible categories may include a cat category, a dog category, a rat category, and a fish category.

At step 504, classification system 102 may generate or receive a top model, consistent with disclosed embodiments. Generating the top model may be based on the training dataset (e.g., based on a data profile of the training dataset). Generating the top model may include selecting and retrieving a model from data 431, model storage 104, remote database 108, and/or another data storage based on an identifier or a selection criterion.

At step 506, classification system 102 may train the top model to classify the training dataset based on the set of possible categories, consistent with disclosed embodiments (e.g., as described in reference to FIG. 3A). Training the top model to classify data may include any method of model training and classifying (e.g., as described in reference to model optimizer 436 and classifier 438). Classifying data at step 506 may include generating a plurality of predicted categories, each predicted category including one or more data samples that are classified by the top model into the predicted category. Step 506 may also include generating predicted labels for each one of the data samples within the training dataset. Each predicted label may represent the predicted category for a respective one of the data samples. Additionally, step 506 may include generating a confidence level for each one of the predicted labels.

At step 508, classification system 102 may generate one or more conjoined categories by combining one or more subsets of possible categories, based on the result of the classifying by the top model, consistent with disclosed embodiments (e.g., as described in reference to FIGS. 3B and 3C). Step 508 may include analyzing the result of the classifying by the top model to determine whether or not to generate one or more conjoined categories. The number of the possible categories in the subset of possible categories may be any number equal to or greater than two, and less than the total number of possible categories in the set of possible categories received at step 502. Step 508 may include generating a conjoined category by combining a subset of possible categories that are being misclassified by the top model, and repeating the step of generating a conjoined category until there is no misclassification among the predicted categories generated by the top model.

In some embodiments, classification system 102 may generate a confusion matrix based on the result of the classifying by the top model, and analyze the confusion matrix to determine whether or not to generate one or more conjoined categories. Therefore, step 508 may include determining the numbers or percentages of misclassifications among a subset of categories predicted by the top model, determining whether the numbers or percentages are greater than, or equal to, a threshold value, and, in response to determining that the numbers or percentages are greater than, or equal to the threshold value, combining the subset of possible categories to form a conjoined category. Step 508 may also include repeating the steps described above until the numbers or percentages of misclassifications among the remaining categories (the categories that are not combined) are below the threshold value.

In some embodiments, classification system 102 may analyze the confidence levels generated for each one of the predicted labels at step 506, and determine whether or not to generate one or more conjoined categories based on the confidence levels. When a subset of predicted labels are very close to each other in terms of confidence level, the categories associated with the predicted labels may be combined to generate a conjoined category. Therefore, step 508 may include determining whether there are two or more predicted labels having confidence levels below a threshold confidence level and the differences between the confidence levels are below a threshold difference value, and, in response to determining that there are such predicted labels, generating a conjoined category by combining the categories associated with the predicted labels. Step 508 may further also include repeating the steps described above until the confidence levels of the remaining categories are above the threshold confidence level.

At step 510, classification system 102 may update the set of possible categories based on the one or more conjoined categories generated at step 508, consistent with disclosed embodiments (e.g., as described in reference to FIGS. 3B and 3C). In some embodiments (e.g., as described in reference to FIG. 3B), updating the set of possible categories at step 510 may include adding the one or more conjoined categories into the set of possible categories. In some alternative embodiments (e.g., as described in reference to FIG. 3B), updating the set of possible categories at step 510 may include adding the one or more conjoined categories into the set of possible categories, and deleting the possible categories joined by the one or more conjoined categories from the set of possible categories.

At step 512, classification system 102 may update the top model based on the updated set of possible categories, consistent with disclosed embodiments. Updating the top model may include any method of model training (e.g., as described in reference to model optimizer 436). For example, model optimizer 436 may update one or more of model parameters, training criteria, and performance metric, of the top model in view of the updated set of possible categories.

At step 514, classification system 102 may classify the training dataset by using the updated top model based on the updated set of possible categories, consistent with disclosed embodiments (e.g., as described in reference to FIGS. 3B and 3C). Classifying data at step 514 may include any method of classifying data (e.g., as described in reference to classifier 438). Similar to step 506, classifying data at step 514 may include generating a plurality of predicted categories, generating predicted labels for each one of the data samples within the training dataset, and generating a confidence level for each one of the predicted labels. Here, because the update set of possible categories includes one or more conjoined categories, the predicted categories generated at step 514 may include one or more conjoined categories.

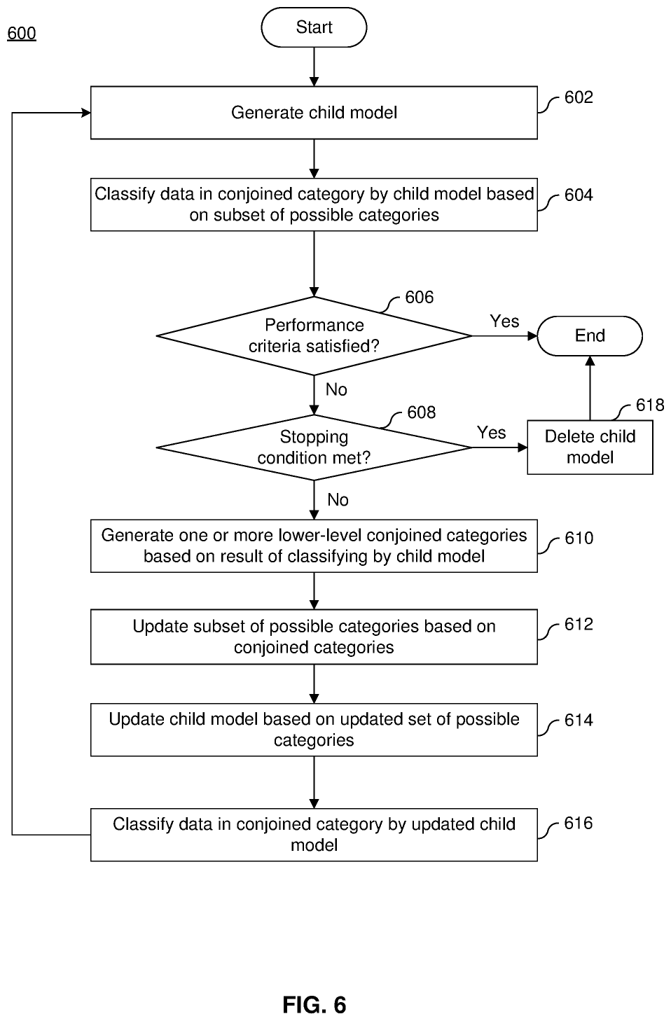

At step 516, classification system 102 may generate one or more child models for the one or more conjoined categories generated at step 514 consistent with disclosed embodiments (e.g., as described in reference to FIGS. 3D, 3E, and 3F). Step 516 may include, for each conjoined category, generating a child model to classify data samples within the conjoined category, and analyzing the result of the classifying by the child model to determine if one or more lower-level conjoined categories need to be generated, and if one or more lower-level conjoined categories need to be generated, generating a lower-level child model for each one of the lover-level conjoined categories. Step 516 will be described in further detail with reference to FIG. 6.

At step 518, classification system 102 may construct a hierarchical classification model including the updated top model and the one or more child models generated at step 516, consistent with the disclosed embodiments (e.g., as described in reference to FIGS. 3D, 3E, and 3F). The top model and the child models may be arranged in a tree structure including the top model and one or more levels of child models. For example, as depicted in FIG. 2, hierarchical classification model 200 includes top model 202, first-level child models 204a and 204b, and second-level child model 204c. Each child model is connected with its parent model, which is either a higher-level child model or the top model.

At step 520, classification system 102 may store the hierarchical classification model in a storage device (e.g., in data 531 or model storage 104). Additionally, at step 520, classification system 102 may transmit the hierarchical classification model to another component of system 100 (e.g., client device 110) and/or a component outside system 100. Classification system 102 may further display a visual representation of network layers in an interface (e.g., interface 522), such as a table, a graph, etc.

FIG. 6 depicts exemplary process 600 for generating one or more child models, consistent with disclosed embodiments (e.g., as described in relation to FIGS. 3D, 3E, and 3F). Process 600 may be performed as a part of step 516 in process 500, to classify data in a predicted conjoined category output by a top model. When the top model outputs more than one predicted conjoined category, process 600 may be repeated for each one of the predicted conjoined categories.

In some embodiments, classification system 102 may perform process 600 using programs 435. One or more of model optimizer 436 or classifier 438, and/or other components of programs 435 may perform operations of process 600, consistent with disclosed embodiments. It should be noted that other components of system 100, including, for example, client device 110, may perform operations of one or more steps of process 600.

Consistent with disclosed embodiments, steps of process 600 may be performed on one or more cloud services using one or more ephemeral container instances (e.g., AMAZON LAMBDA). For example, at any of the steps of process 600, classification system 102 may generate (spin up) an ephemeral container instance to execute a task, assign a task to an already-running ephemeral container instance (warm container instance), or terminate a container instance upon completion of a task. As one of skill in the art will appreciate, steps of process 600 may be performed as part of an application interface (API) call.

At step 602, classification system may generate or receive a child model, consistent with disclosed embodiments (e.g., as described in reference to FIG. 3D). Generating the child model may be based on the data samples in the conjoined category (e.g., based on a data profile of the training dataset). Generating the child model may include selecting and retrieving a model from data 431, model storage 104, remote database 108, and/or another data storage based on an identifier or a selection criterion.

At step 604, classification system 102 may train the child model to classify data samples in the conjoined category based on a subset of possible categories, consistent with disclosed embodiments (e.g., as described in reference to FIG. 3D). The subset of possible categories may be the categories combined by the conjoined category. Training the child model to classify data may include any method of model training and classifying (e.g., as described in reference to model optimizer 436 and classifier 438). Classifying data at step 604 may include generating a plurality of predicted categories, each predicted category including one or more data samples that are classified by the top model into the predicted category. Step 604 may also include generating predicted labels for each one of the data samples within the conjoined category. Each predicted label may represent the predicted category for a respective one of the data samples. Additionally, step 604 may include generating a confidence level for each one of the predicted labels.

At step 606, classification system 102 may determine whether a performance criterion is satisfied, consistent with disclosed embodiments. In some embodiments, at step 606, classification system 102 may generate a confusion matrix based on the result of the classifying by the child model, and determine whether the performance criterion is satisfied based on the confusion matrix. For example, if the number or the percentage of the misclassifications among a subset of categories predicted by the child model is below a threshold value, classification system 102 may determine that the performance criterion is satisfied. In some alternative embodiments, at step 606, classification system 102 may determine whether the performance criterion is satisfied based on the confidence levels generated by the child model. For example, if the confidence levels are greater than, or equal to, a threshold confidence level, classification system 102 may determine that the performance criterion is satisfied.

If the performance criterion is satisfied (i.e., if the determination at step 606 is “yes”), process 600 will end. That is, the child model generated at 602 may be used as the child model for classifying data in the corresponding conjoined category.

If the performance criterion is not satisfied (i.e., if the determination at step 606 is “no”), process 600 will proceed to step 608. At step 608, classification system 102 may determine whether a stopping condition is met, consistent with disclosed embodiments. In some embodiments, at step 608, classification system 102 may determine whether the result of the classifying by the child model is an improvement over the result of the classifying by a parent of the child model. When the result of the classifying by the child model is an improvement, the stopping condition is not met. On the other hand, when the result of the classifying by the child model is not an improvement, the stopping condition is met. The parent of the child model may be a top model or an upper-level child model. For example, if the child model is child model 304a or 304b in FIG. 3D, then the parent is top model 302. If the child model is child model A-B 304c in FIG. 3F, then the parent is child model A-B-C 304a.

In some embodiments, at step 608, classification system 102 may determine whether the result of the classifying by the child model is an improvement based on the number or percentage of misclassifications by the child model. If the number or percentage of misclassifications by the child model is reduced compared to that of the parent model, then classification system 102 may determine that the stopping condition is not met. In some alternative embodiments, at step 608, classification system 102 may determine whether the result of the classifying by the child model is an improvement based on the confidence levels output by the child model. If the confidence levels output by the child model are increased compared to the ones output by the parent model, then classification system 102 may determine that the stopping condition is not met.

If the stopping condition is met (i.e., if the determination at step 608 is “yes”), process 600 will proceed to step 618. At step 618, classification system 102 may delete the child model generated at step 602. Then, process 600 will end. That is, classification system 102 may determine not to add a child model for the conjoined category. Thus, each data sample in the conjoined category will be associated a predicted level indicating the conjoined category as the final classification result for the data sample.

If the stopping condition is not met (i.e., if the determination at step 608 is “no”), process 600 will proceed to step 610. At step 610, classification system 102 may generate one or more lower-level conjoined categories based on the result of the classifying by the child model, consistent with disclosed embodiments (e.g., as described in reference to FIG. 3E). Step 610 may include analyzing the result of the classifying by the child model to determine which ones of the categories predicted by the child model are confused with each other (e.g., categories that include misclassifications), and generating a lower-level conjoined category by combining the categories that are confused with each other. Step 610 may include repeating the step of generating a conjoined category until there is no misclassification among the predicted categories generated by the child model.

At step 612, classification system may update the subset of possible categories based on the one or more lower-level conjoined categories generated at step 610, consistent with disclosed embodiments (e.g., as described in reference to FIG. 3E). In the embodiment depicted in FIG. 3E, updating the subset of possible categories at step 612 may include adding the one or more lower-level conjoined categories, and deleting the categories combined by the one or more lower-level conjoined categories. In some alternative embodiments (not depicted), updating the subset of possible categories at step 612 may include adding the one or more lower-level conjoined categories, without deleting the categories combined by the one or more lower-level conjoined categories.

At step 614, classification system 102 may update the child model based on the updated subset of possible categories, consistent with disclosed embodiments. Updating the child model may include any method of model training (e.g., as described in reference to model optimizer 436). For example, model optimizer 436 may update one or more of model parameters, training criteria, and performance metric, of the child model in view of the updated subset of possible categories.

At step 616, classification system 102 may classify the data samples within the conjoined category by using the updated child model based on the updated subset of possible categories, consistent with disclosed embodiments (e.g., as described in reference to FIG. 3E). Classifying data at step 616 may include any method of classifying data (e.g., as described in reference to classifier 438). Similar to step 604, classifying data at step 616 may include generating a plurality of predicted categories, generating predicted labels for each one of the data samples within the conjoined category, and generating a confidence level for each one of the predicted labels. Here, because the update subset of possible categories includes one or more conjoined categories, the predicted categories output at step 616 may include one or more lower-level conjoined categories.

As shown in FIG. 6, after step 616, process 600 may return to step 602, in which classification system 102 may generate a lower-level child model for one of the lower-level conjoined categories output by the child model at step 616. Thus, steps 602, 604, 606, 608, 610, 612, 614, and 614 may be repeated until a performance criterion is satisfied or a stopping condition is met.

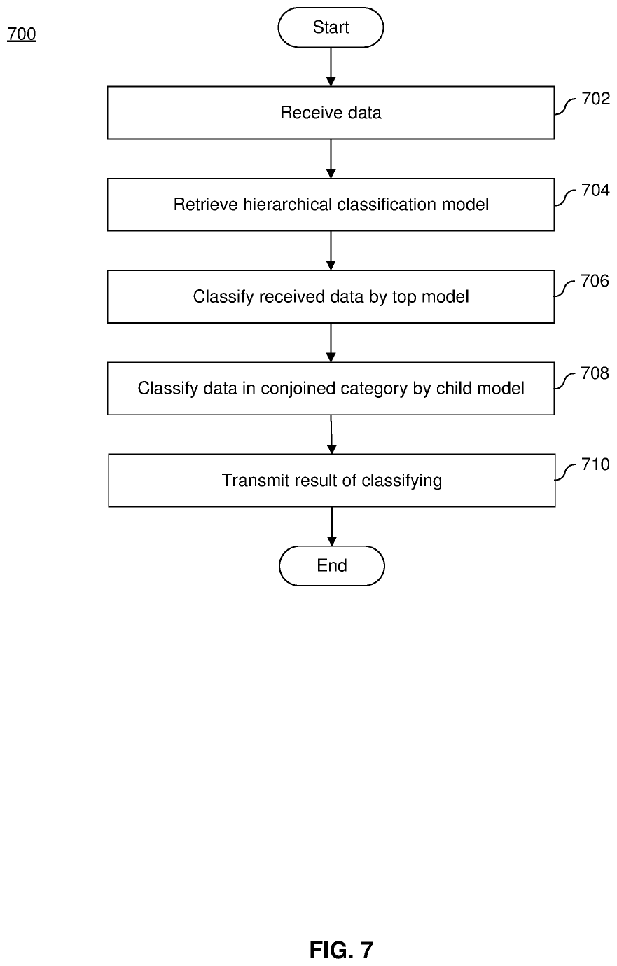

FIG. 7 depicts exemplary process 700 for classifying data using a hierarchical classification model, consistent with disclosed embodiments (e.g., as described in relation to FIG. 2). In some embodiments, classification system 102 may perform process 700 using programs 435. One or more of classifier 438, and/or other components of programs 435 may perform operations of process 700, consistent with disclosed embodiments. It should be noted that other components of system 100, including, for example, client device 110 may perform operations of one or more steps of process 700.

Consistent with disclosed embodiments, steps of process 700 may be performed on one or more cloud services using one or more ephemeral container instances (e.g., AMAZON LAMBDA). For example, at any of the steps of process 700, classification system 102 may generate (spin up) an ephemeral container instance to execute a task, assign a task to an already-running ephemeral container instance (warm container instance), or terminate a container instance upon completion of a task. As one of skill in the art will appreciate, steps of process 700 may be performed as part of an application interface (API) call.

At step 702, classification system 102 may receive data, consistent with disclosed embodiments. Data received at step 702 may include any type of data in any format, with any number of dimensions, as previously described. Data received at step 702 may include a plurality of data elements. In some embodiments, classification system 102 may receive an identifier of a hierarchical classification model or a selection criterion for selecting a hierarchical classification model at step 702.

At step 704, classification system 102 may retrieve a hierarchical classification model, consistent with disclosed embodiments. As previously described, a hierarchical classification model may include a top model and one or more child models arranged in a tree structure. The top model may include a machine-learning model trained to classify the data received at step 702, to output a plurality of predicted categories. The plurality of predicted categories include one or more conjoined categories. Each one of child models may include a machine-learning model trained to classify data in a corresponding one of the conjoined categories. In some embodiments, retrieving a hierarchical classification model may include selecting and retrieving an embedding network layer from a model storage based on an identifier or a selection criterion.

At step 706, classification system 102 may classify the received data by using the top model, consistent with disclosed embodiments. Step 706 may include classifying, by the top model, the received data into a plurality of categories. The categories may include one or more conjoined categories. Each conjoined category may contain data that belongs to a subset of the categories. Classifying data at step 706 may include generating a plurality of predicted categories, each predicted category including one or more data elements that are classified by the top model into the predicted category. Step 706 may also include generating predicted labels for the data elements (for example, each one of the data elements) within the received data. Each predicted label may represent the predicted category for a respective one of the data elements. Additionally, step 706 may include generating a confidence level for each one of the predicted labels.

At step 708, classification system 102 may classify data in the one or more conjoined categories by using the one or more child models, consistent with disclosed embodiments. Step 708 may include classifying a conjoined category by using a child model that corresponds to the conjoined category. If the top model outputs a plurality of conjoined categories, or if a child model outputs a plurality of conjoined categories, step 708 may also include repeatedly each one of the conjoined categories by using a child model that corresponds to the conjoined category. Classifying data at step 708 may include generating a plurality of predicted categories, each predicted category including one or more data elements that are classified by the child model into the predicted category. Step 708 may also include generating predicted labels for each one of the data elements within each conjoined category. Each predicted label may represent the predicted category for a respective one of the data elements. Additionally, step 708 may include generating a confidence level for each one of the predicted labels.

At step 710, classification system 102 may transmit the results of the classifying by the hierarchical classification model, consistent with disclosed embodiments. In some embodiments, the results of the classifying may include the predicted labels and their associated confidence levels predicted by the top model and the one or more child models for the data elements in the received data. Transmitting the results of the classifying at step 710 may include transmitting the predicted labels to another component of system 100 (e.g., client device 110) and/or a component outside system 100. Transmitting the results of the classifying at step 710 may include displaying a visual representation of final classified data, in an interface (e.g., interface 422).

In some embodiments, instead of classifying the received data by the top model and then by the one or more child models, the receive data may be directly classified by the one or more child models. For example, the data elements in the received data may be input into each child model, and each child model may generate a classification result (e.g., predicated label) and performance level (e.g., confidence level) of the classification result for each data element. For each data element, the classification result having the highest performance level may be determined as the final classification result for the data element. In this manner, less number of classification models may be used to obtain satisfactory results.

Systems and methods disclosed herein involve unconventional improvements over conventional approaches for classifying data. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

Computer programs based on the written description and methods of this specification are within the skill of a software developer. The various functions, scripts, programs, or modules can be created using a variety of programming techniques. For example, programs, scripts, functions, program sections or program modules can be designed in or by means of languages, including JAVASCRIPT, C, C++, JAVA, PHP, PYTHON, RUBY, PERL, BASH, or other programming or scripting languages. One or more of such software sections or modules can be integrated into a computer system, non-transitory computer-readable media, or existing communications software. The programs, modules, or code can also be implemented or replicated as firmware or circuit logic.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

What is claimed is:

1. A system for classifying data, the system comprising:
a memory unit storing instructions; and
one or more processors configured to execute the instructions to perform operations comprising:
receiving data from a client device;
retrieving a hierarchical classification model from a storage device, the hierarchical classification model comprising a top model and a plurality of child models arranged in a tree structure;
classifying, by the top model, the received data into a plurality of categories, the categories comprising a conjoined category containing data that belongs to a subset of the categories;
classifying, by a child model of the top model, the received data within the conjoined category; and
transmitting, to the client device, a result of the classifying by the top model and the child model.

2. The system of claim 1, wherein:
the conjoined category is a first conjoined category, and the child model is a first child model;
the operations further comprise:
iteratively classifying, by a child model other than the first child model, the received data in a conjoined category other than the first conjoined category until a bottom of the tree structure is reached.

3. The system of claim 1, wherein the operations further comprise:
generating the hierarchical classification model based on a training dataset comprising a plurality of data elements; and
storing the hierarchical classification model in the storage device.

4. The system of claim 3, wherein generating the hierarchical classification model comprises:
receiving the training dataset;
generating the top model;
classifying, by the top model, the training dataset based on a plurality of possible categories, the possible categories comprising categories to which the data elements belong;
generating a first conjoined category based on the result of classifying the training dataset by the top model, the first conjoined category being generated by joining a subset of possible categories;
updating the possible categories based on the first conjoined category;
updating the top model based on the updated possible categories; and
classifying, by the updated top model, the training dataset.

5. The system of claim 4, wherein generating a first conjoined category comprises:
generating a confusion matrix based on a result of classifying the training dataset by the top model; and
generating the first conjoined category based on the confusion matrix.

6. The system of claim 4, wherein generating a first conjoined category comprises:
generating a plurality of confidence levels for respective ones of the data elements in the training dataset; and
generating the first conjoined category based on the confidence levels.

7. The system of claim 4, wherein updating the possible categories comprises:
adding the first conjoined category into the possible categories.

8. The system of claim 7, wherein updating the possible categories comprises:
adding the first conjoined category into the possible categories; and
deleting the possible categories joined by the first conjoined category from the possible categories.

9. The system of claim 4, wherein:
classifying the training dataset by the updated top model comprises outputting the first conjoined category by the updated top model; and
the operations further comprise generating a child model for the conjoined category.

10. The system of claim 4, wherein:
classifying the training dataset by the updated top model comprises outputting the first conjoined category by the updated top model; and
the operations further comprise:
generating a child model;
classifying, by the child model, data in the conjoined category, based on the subset of possible categories;
determining whether a performance criterion is satisfied based on a result of the classifying by the child model;
in response to determining that the performance criterion is not satisfied, determining whether a stop condition is met based on the result of the classifying by the child model;
in response to determining that the stopping condition is not met, generating a second conjoined category based on the result of the classifying by the child model, the second conjoined category being generated by joining a plurality of possible categories in the subset of possible categories;
updating the subset of possible categories based on the second conjoined category; and
updating the child model based on the updated subset of possible categories;
classifying, by the updated child model, the data in the conjoined category.

11. The system of claim 10, wherein determining whether a performance criterion is satisfied comprises:
generating a confusion matrix based on the result of the classifying by the first child model; and
determining whether the performance criterion is satisfied based on the confusion matrix.

12. The system of claim 10, wherein determining whether a performance criterion is satisfied comprises:
generating a plurality of confidence levels for respective ones of the data elements in the conjoined category; and
determining whether the performance criterion is satisfied based on the confidence levels.

13. The system of claim 10, wherein determining whether a stopping condition is met comprises:
determining whether the result of the classifying by the child model is an improvement over the result of the classifying by the top model before the top model is updated; and
in response to determining that the result of the classifying by the child model is not an improvement, determining that the stopping condition is met.

14. The system of claim 10, wherein the operations further comprise:
in response to determining that the stopping condition is met, deleting the child model.

15. The system of claim 10, wherein updating the subset of possible categories comprises:
adding the second conjoined category into the subset of possible categories.

16. The system of claim 10, wherein updating the subset of possible categories comprises:
adding the second conjoined category into the subset of possible categories; and
deleting the possible categories joined by the second conjoined category from the subset of possible categories.

17. A system for generating a hierarchical classification model, the system comprising:
a memory unit storing instructions; and
one or more processors configured to execute the instructions to perform operations comprising:
receiving a training dataset comprising a plurality of data elements;
generating a top model;
classifying, by the top model, the training dataset based on a plurality of possible categories, the possible categories comprising categories to which the data elements belong;
generating a first conjoined category based on a result of the classifying, the first conjoined category being generated by joining a subset of the possible categories;
updating the possible categories based on the first conjoined category;
updating the top model based on the updated possible categories;
classifying, by the updated top model, the training dataset, the classifying resulting in a conjoined category;
generating a child model of the top model for the conjoined category;
constructing a hierarchical classification model including the top classification model and the child model arranged in a tree structure; and
storing the hierarchical classification model in a storage device.

18. The system of claim 17, wherein generating the child model comprises:
generating a preliminary child model;
classifying, by the preliminary child model, data in the conjoined category based on the subset of possible categories;
determining whether a performance criterion is satisfied based on a result of the classifying by the preliminary child model;
in response to determining that the performance criterion is not satisfied, determining whether a stopping condition is met based on the result of the classifying by the preliminary child model;
in response to determining that the stopping condition is not met, generating a second conjoined category based on the result of the classifying by the preliminary child model, the second conjoined category being generated by combining two possible categories in the subset of possible categories;
updating the subset of possible categories based on the second conjoined category;
updating the preliminary child model based on the updated subset of possible categories; and
classifying, by the updated child model, the data in the conjoined category.

19. The system of claim 18, wherein in response to determining that the stopping condition is not met, the operations further comprise deleting the preliminary child model.

20. A method for classifying data, comprising:
receiving data from a client device;
retrieving a hierarchical classification model from a storage device, the hierarchical classification model including a top model and a plurality child models arranged in a tree structure;
classifying, by the top model, the received data into a plurality of categories, the categories comprising a conjoined category containing data that belongs to a subset of the categories;
classifying, by a child model of the top model, the received data within the conjoined category; and
transmitting, to the client device, a result of the classifying by the top model and the child model.
